(19) United States
(12) Patent Application Publication
(10) Pub. No.: US 2005/0288067 A1
(43) Pub. Date: Dec. 29, 2005

(54) Incoming call alert adapter for mobile devices

(76) Inventor: Harry Lee Wainwright, Wilmington, NC (US)

Correspondence Address: SANFORD J. PILTCH, ESQ., 1132 HAMILTON STREET, SUITE 201, ALLENTOWN, PA, 18101, US

(21) Appl. No.: 11/165,887

(22) Filed: Jun. 24, 2005

Related U.S. Application Data
(60) Provisional application No. 60/582,153, filed on Jun. 24, 2004.
(60) Provisional application No. 60/586,929, filed on Jul. 12, 2004.

(51) Int. Cl. H04M 1/00

(52) U.S. Cl. 455/567

(57) ABSTRACT

An incoming call alert adapter makes use of connections to audio player devices and audio output devices for alerting the users of these devices to incoming calls on a nearby mobile telecommunications device. The alert adapter interrupts an audio signal that passes from the audio player device to the audio output device through a series of connections within the alert adapter when an incoming call-back signal is detected on a nearby mobile telecommunications device. The interrupted audio signal alerts the user, who may riot have heard the audible alert of the mobile telecommunications device of the incoming call over the audio from the audio playback device.

### BACKGROUND OF THE INVENTION

The present invention relates generally to an incoming call alert adapter for mobile telecommunications devices. Particularly, the present invention relates to an incoming call alert adapter configured to communicate with input and output sound devices upon receiving a signal from a cellular phone, alerting a user to an incoming call on the cellular phone.

Visible and audible incoming call alert devices have been used to alert users to an incoming call on mobile telecommunications devices. Notifying a user of an incoming call on mobile phones has been dependent upon an internal mechanism eliciting an audio signal through a built-in speaker or through an earpiece designed to be connected directly to the phone itself. Examples of such call alert devices are disclosed in U.S. Pat. No. 4,993,061 (Hsieh), U.S. Pat. No. 5,694,467 (Young, III), U.S. Pat. No. 5,978,689 (Tuoriniemi), U.S. Pat. No. 5,991,637 (Mack, II), U.S. Pat. No. 6,091,812 (Iglehart), U.S. Pat. No. 6,154,649 (Reichstein), and U.S. Pat. No. 6,519,475 B1 (Kim).

Some mobile phones have internal radios to receive audio. Yet, other mobile phones have memory to store rsound files for playback, whereby the internal radio is shut off automatically when a call is received and the user is alerted by the playback of the stored sound file through an earpiece connected directly to the phone. Other mobile phone devices are designed to be manually shut off when other audio sources are desired to be heard. In addition, some mobile phones alert the user through vibrations triggered when the phone receives a call. Lastly, light emitting diodes coupled with an integrated circuit (IC) containing an RF receiver are applied in some examples of accessory jewelry and in specially adapted antennas that result in flashing in pre-programmed sequences when a call is received on a nearby mobile phone;

Previous alert systems are insufficient in alerting a user who is listening to music generated from an independent audio source through stereo headphones or a set of external speakers when their mobile phone receives a call while positioned in a place out of direct vision, such as in different room location, being clipped on their belt, in a coat pocket, placed inside a purse, or carried in a briefcase. Furthermore, vibrations can be an inadequate alert system in environments in which vibrations are inherently present, such as, when jogging or when riding a bike or motorcycle. In many cases, the vibrations cannot be felt unless clipped onto a person's body, but even so, can be too minor to allow a person in motion to feel the small vibrations. In addition, flashing light emitting diodes are difficult, if not impossible, to be seen on a phone in the daylight, if they are positioned out of the line of sight, or located inside some other mode of transporting the device.

Previous alert systems make use of tiny earphones, small monophonic earpieces, and 4-prong micro-mini jack connections for specialized headpieces designed for people to use with their mobile phones that contain FM radios and MPEG players but do not have the ability of listening to stereo through their own standard high performance headsets requiring standard 3-prong mini jacks. Alert systems also do not allow a user to program special audio sounds to become the alert sound for any internal call notification method built into independent CD-Players, FM radios, cassette players, MPEG players, or any other type of independent stereo audio output device. Other alert systems also do not allow for an incoming call on a mobile phone to shut off a car or home stereo speaker output for the additional convenience of automatically being able to hold a conversation without loud ambient noise.

U.S. Pat. No. 4,993,061 (Hsieh) discloses a portable stereo and telephone combination system which plays stereo sounds but also includes a base unit and handset of an ordinary cordless radio telephone. The system allows earphone wearers to hear a telephone call by means of the radio without affecting ordinary uses of the stereo. The system provides stereo from an internal radio and detects incoming calls from the internal phone device. The system does not provide an independent call alert adapter that may be connected to other types of audio devices. Furthermore, the system does not pertain to the detection and alert of incoming calls on mobile telecommunication devices or other external phone devices.

U.S. Pat. No. 5,694,467 (Young, III) discloses an integrated sound/telephone headset system in which a sound-generating device is coupled to a telephonic instrument and a headset having a microphone and earphones. A control system connects the headset to at least one of the sound-generating and the telephonic instrument as a function of the indicated mode. The control system receives music from the music source, a telephone ring signal from a telephone line, the telephone audio, and ambient sounds received by the microphone. The phone can be answered with its handset, while the headset is connected to a mixer with audio input from the music source, a microphone detecting ambient sounds, and a ring tone indicating a ring signal on the telephone line. Or the user may initiate or answer a call by lowering the microphone, which switches the headset from the mixer to the telephone and connects the telephone to the telephone line. The system does not provide an independent call alert adapter that may be connected to other types of audio devices. Furthermore, the system does not pertain to the detection and alert of incoming calls on mobile telecommunication devices or other external phone devices.

U.S. Pat. No. 5,978,689 (Tuoriniemi) discloses a portable communication and audio system which includes a radio telephone integrated with an audio device. The headset allows the user to receive telephone ring alert signals discretely through the speakers when a telephone ring alert sound is undesirable. The headset also gives the user the option to choose between an audio program and a telephone conversation through the use of a user-operated switch. The system gives a user a hands-free alternative to listen to an audio program and to initiate phone calls without taking a headset. The system is its own audio device integrated with the radio telephone either as one unit or through a hardwire link. Thus, the system must be integrated with the telephone in order to detect a call. Further, the system does not allow a user to disconnect the call alert device from one audio player and re-connect to a different audio player since the device already has an internal audio player device.

U.S. Pat. No. 5,991,637 (Mack, II) discloses a radio headset receiver which is capable of automatically and/or semi-automatically activating a telephone interface controller such that the passive radio headset can be integrated with active communications devices such as portable telephones, walkie-talkies, intercoms, or monitoring devices. In the event a telephone call is received, a switch device within the headset interrupts audio data from the passive communications device (radio) and connects the audio output of the active communications device to the speakers. Both the passive and active devices are combined into one unit. Thus, the device does not allow a user to disconnect the device from one audio player and re-connect to a different audio player since the device already has an internal radio. Furthermore, the system must be integrated with the active communications device where, in the event a telephone call is received, a switch interrupts audio data from the radio and connects the active communications device to the speakers. The headset does not alert the user of a call with an alert signal.

U.S. Pat. No. 6,091,812 (Iglehart) discloses an apparatus for automatically switching a headset between a telephone and a second audio source. A switching circuit connects the telephone to the headset in response to sensing a call on a telephone line. Otherwise, the switching circuit connects the second audio source to the headset. The device detects incoming calls through a telephone line connected to a telephone handset; therefore, the device is not enabled to work with mobile telecommunication devices for alerting users of mobile telecommunications devices of an incoming call.

U.S. Pat. No. 6,154,649 (Reichstein) discloses a radio receiver with an integrated telephone device, which is used for the switching of loudspeakers between radio reception and telephone reception. In telephone mode, when a preset signal is received by the radio receiver the loudspeakers are partially switched over to radio reception. In radio reception mode, the loudspeakers are partially switched over to telephone reception when the telephone is being used, allowing the user to simultaneously listen to the radio and use the telephone. The device is not a call alert system for alerting a user listening to audio of an incoming call. The system does not provide an independent call alert adapter that may be connected to other types of audio devices. Furthermore, the system does not pertain to the detection and alert of incoming calls on mobile telecommunication devices or other external phone devices.

U.S. Pat. No. 6,519,475 B1 (Kim) discloses an earphone-microphone combination including a radio module that shifts it operation modes between telephone mode and radio mode. A switching device changes the operational mode of the radio module between telephoning mode and radio mode upon receiving mode signals inputted by the user. The device is not a call alert system for alerting a user listing to audio of an incoming call but instead allows a user to manually switch from radio mode to telephone mode on an earphone-microphone.

Therefore, what is needed is an external call alert system that notifies a person listening to music generated from an independent audio source through stereo headphones or a set of external speakers to an incoming call on their mobile phone by interrupting the audio signal from the audio source. There is still a further need for a call alert adapter that can be separately connected to different types of audio devices. There is also a corresponding need for enhancements for a call alert system that can detect incoming calls on mobile telecommunication devices without a hardwire connection. There is still a corresponding need for enhancements for a call alert system with internal or external memory for storing an independent call alert signal.

It is an object of the present invention to overcome the deficiencies in past call alert systems as indicated above. It is another object of the present invention to provide an improved call alert device independent of the cellular and audio devices.

Other objects will appear hereinafter.

### SUMMARY OF THE INVENTION

The present invention provides an incoming call alert adapter for alerting persons listening to an audio output generated from an audio source, such as, but not limited to, radio players, CD players, tape cassette players, DVD players, CVD players, and MPEG players, of incoming calls on mobile telecommunications devices, such as mobile or cellular phones. More specifically, the device interrupts the audio signal from the audio source by either disconnecting the audio source from an audio output device, such as a speaker or headset, reducing volume of the audio output, placing the alert signal on top of the audio output, or replacing the audio signal with a ringing sound or other type of audio file that alerts the mobile phone user of an incoming call.

The alert adapter contains an input connector or female jack for accepting a plug, male jack, or other type of connection from an audio output device. The alert adapter also contains an output connector, plug, or male jack designed to fit into any input connector or female jack of any number of audio player devices. The input connector of the adapter provides a connection to an audio output line provided by the audio output device. The output connector of the adapter provides an audio path that the adapter intercepts from the audio player device.

The alert adaptor contains a small coin cell battery compartment and printed circuit board. The circuit contains an RF receiver tuned to the appropriate mobile phone frequency (900 MHz in the USA and other assigned radio frequency bands for foreign countries to be determined accordingly), an electronic switching relay, memory, and associated components necessary to activate the switching relay to switch the audio output from the incoming audio signal received from the audio player device to the output of an audio file, such as the sound of a phone ringing, from internal memory when the appropriate frequency is detected. A processor may also be configured with other detection methods for activating the switching relay when an incoming call is received by a mobile phone.

Although the internal antenna of the alert adapter is not sensitive enough to detect the incoming signal from mobile transmitting towers to any mobile phone, mobile phones, upon receiving a call, transmit a call-back signal on the same frequency having sufficient signal strength to be easily received by the detection circuit inside the call alert adapter device in the same fashion as the “Cell-Phone” RF receiver alerting light emitting diodes (LED's) in accessories and LED flashing antennas function. The sensitivity of the receiver portion is set to activate only when a signal is detected within a few feet of the mobile phone that is transmitting the return verification signal so as to prevent false activations of other mobile phones receiving calls in the immediate area. In addition, an optional method of including separate sensitivities to allow a person to adjust the distance the unit is able to receive the call-back signal necessary to activate the internal relay (or alert signal output without a relay or switch) for sending the audio alert to the user may be included.

The alert adapter may also transmit audio output and input through a radio frequency or electrical connection from a headset and microphone to a mobile phone. The alert adapter detects a radio or audio signal sent from the mobile phone and then switches the adapter audio path from the audio source to the input and output of the mobile phone The radio frequency or hard wire connection intercepts the transmission of the audio output of the mobile phone and transmits the audio input from the microphone to the mobile phone. This arrangement allows a person to use a headset and microphone to intercept a call on a mobile phone while listening to the audio output of an audio player device through a headset when there is no on-going call on the mobile phone. This function is particularly useful when a person is driving an automobile and answering a mobile phone is cumbersome. Furthermore, the alert adapter can contain a switch to mute the audio output of the audio player device for quickly shutting off the audio output when the need arises to hear ambient sounds or side conversations.

Furthermore, a light emitting diode, or plurality of light emitting diodes or other display methods, could be used in conjunction with the programming of sound files through the stereo input jack to allow a user the convenience of visual reinforcement when programming the unit. Various blinking patterns of the light emitting diode could denote errors, memory conditions, and successful programmed sound files.

In addition, a method of adding the ability to input custom internal sound files to substitute for the default ring tone located in memory and allow a user to choose between the default ring tone and custom sound files. By providing a manually operated method, Double Pole Double Throw (DPDT) switch or similar switching method, to allow for changing the audio output jack connections to a separate set of lines, the audio output jack can temporarily become the input jack necessary to input custom sound files to be used as the audio alert file output when a mobile phone call is detected.

It is also contemplated that the device can be fitted with an additional transmitter and receiver using a frequency with encryption capabilities such as “Blue Tooth” technology enabling a set of wireless headsets, wireless headphones, or any other type of wireless listening devices and wireless microphones to work in conjunction with the device.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a schematic diagram of an incoming mobile telecommunications call detection and alert system and associated circuit elements coupled to external audio devices in accordance with the present invention.

FIG. 2 is a schematic diagram of another embodiment of the call detection and alert system and associated circuit elements of FIG. 1, coupled to external audio devices in accordance with the present invention.

FIG. 3 is a block diagram showing the control and signal paths between and among the various electrical components shown in FIG. 2.

FIG. 4 is a plan layout view showing one possible configuration of the placement and interconnections of the various electrical components of the present invention.

FIG. 5 is a perspective view of the external components of the present invention.

FIG. 6 is a perspective view of the external components of the present invention showing one possible configuration of the present invention connected to an audio source, an audio output, and in proximity to a mobile phone.

FIG. 7 is a perspective view of the external components of the present invention showing a second possible configuration of the present invention having wired and wireless connections among the adaptor, a mobile phone, and a headset and microphone.

FIG. 8 is a perspective view of the external components of the present invention showing a third possible configuration of the present invention having wired and wireless connections among the adaptor, a mobile phone, and a headset and microphone.

### DETAILED DESCRIPTION OF THE PREFERREB EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

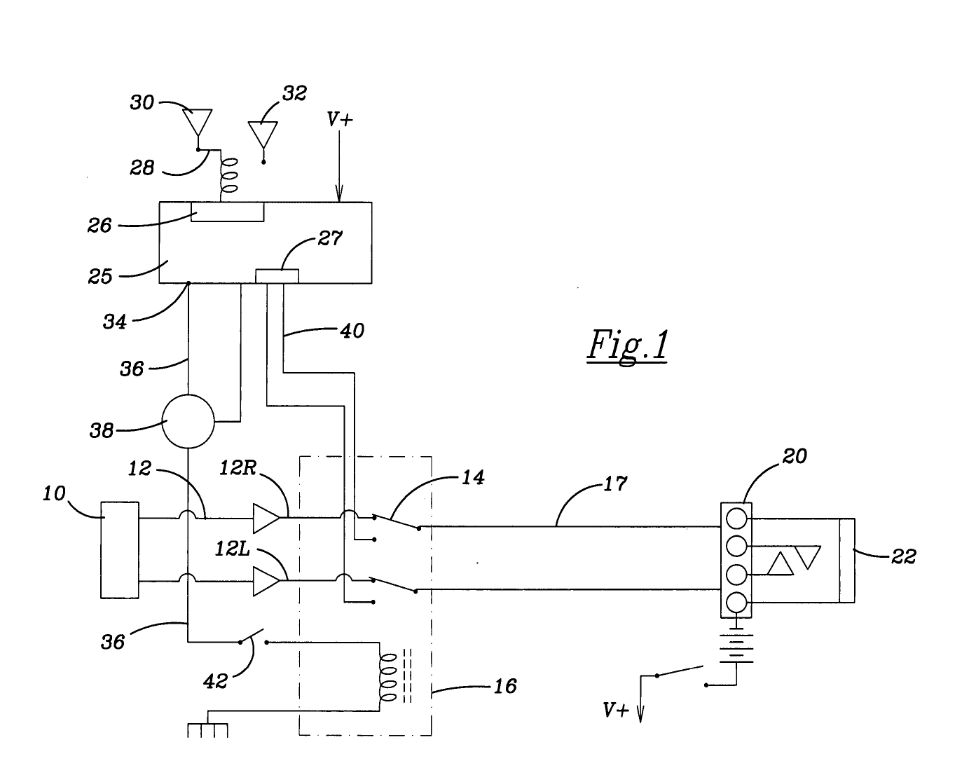

Referring now to the drawings in detail, where like numerals refer to like parts or elements, there is shown in FIG. 1 a portion of the detection and alert system of the present invention. In default position, an audio signal is sent from an audio player device 10, through an audio path 12, through a relay switch 14, as shown in its default position, contained within an electronic switching relay circuit 16. After exiting the electronic switching relay circuit 16, the audio signal is sent through an audio output line 17 to an input connector 20 that is configured to accept a connection from an audio output device 22 such as a male output jack. Audio path 12 may include a right audio path 12R and a left audio path 12L when audio player device 10 is configured in stereo having paired audio output channels, as opposed to configured in mono where there is only a single audio output channel. Audio player device 10 is electrically coupled to electronic switching relay circuit 16 by audio path 12. Thus, in default position, an audio signal passes from its source, audio player device 10, to audio output device 22 where the audio signal can be heard by the user.

Integrated circuit 25 contains an RF receiver 26 and a memory device 27. RF receiver 26 is electrically coupled through a sensitivity switch 28 to an antenna 30 and an alternate sensitivity antenna 32. Sensitivity switch 28 can be used to regulate the sensitivity of RF receiver 26 by switching the connections between antenna 30 and alternate sensitivity antenna 32, where alternate sensitivity antenna 32 has a different sensitivity level from the sensitivity of antenna 30. RF receiver 26 is coupled to memory device 27, where memory device 27 is used for storing an audio file. When integrated circuit 25 receives a carrier signal from RF receiver 26 upon the detection of a call-back verification signal from a mobile telecommunications device by antenna 30 or alternate sensitivity antenna 32, integrated circuit 25 sends a signal to begin current flow from a control signal connection 34, through a control signal path 36 to a transistor amplifier 38. Current flow continues through transistor amplifier 38 on control signal path 36 to electronic switching relay circuit 16, switching relay switch 14 to its non-default position. Changing the switch position of relay switch 14 from default to non-default, interrupts audio path 12 from audio player device 10 and changes the connection to an audio file output line 40 leading from memory device 27 of integrated circuit 25. With relay switch 14 in its non-default position, an audio file stored in memory device 27 passes through audio file output line 40, through relay switch 14, and is routed to input connector 20 to be heard by audio output device 22. A deactivation switch 42 may be placed on control signal path 36 where, in its opened position, deactivation switch 42 would prevent the triggering of the electronic switching relay circuit 16 through control signal path 36, keeping relay switch 14 in its default position.

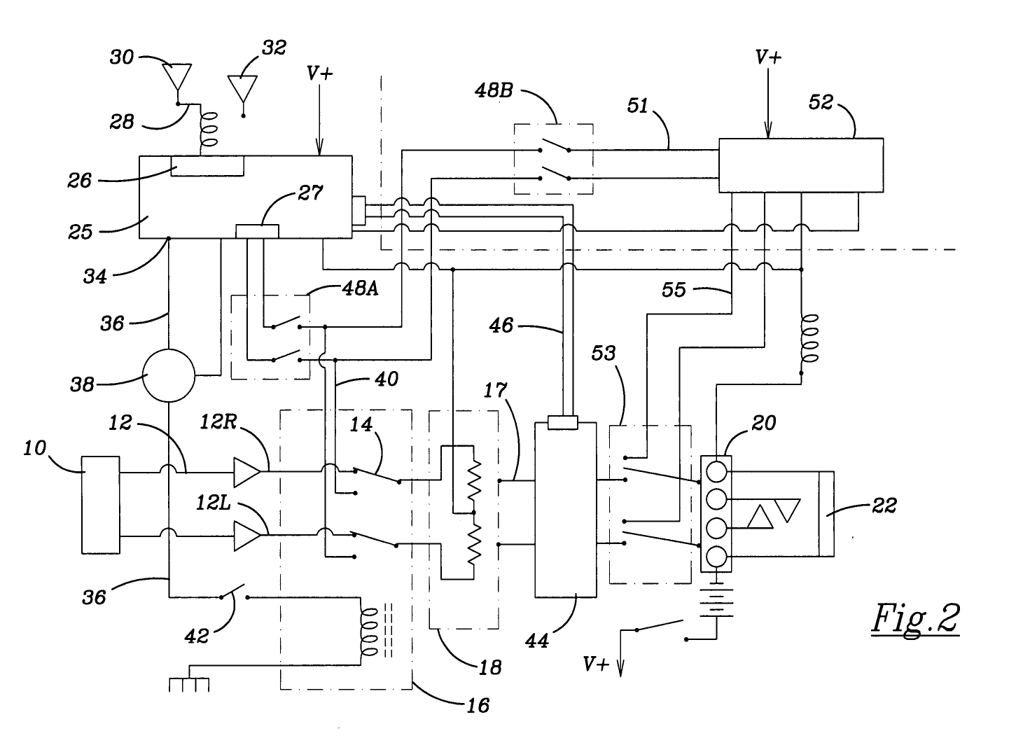

The schematic diagram of FIG. 2 illustrates another embodiment of the detection and alert system in accordance with the present invention. In default position, an audio signal is sent from an audio player device 10, through an audio path 12, through a relay switch 14, as shown in its default position, contained within an electronic switching relay circuit 16. After exiting the electronic switching relay circuit 16, the audio signal is sent through an audio output line 17, through a manual volume control 18 coupled to audio output line 17, to an input connector 20 which is configured to accept a connection from an audio output device 22 such as a male output jack. Audio path 12 may include a right audio path 12R and a left audio path 12L when audio player device 10 is configured in stereo having paired audio output channels, as opposed to configured in monb where there is only single audio output channel. Audio player device 10 is electrically coupled to electronic switching relay circuit 16 by audio path 12. Manual volume control 18 is a potentiometer connected to a knob or some other type of control mechanism on the alert adapter. Manual volume control 18 regulates the audio signal before the audio signal leaves the adapter. Thus, in default position, an audio signal passes from its source, audio player device 10, to audio output device 22 where the audio signal can be heard by the user.

Integrated circuit 25 contains an RF receiver 26 and a memory device 27. RF receiver 26 is electrically coupled through a sensitivity switch 28 to an antenna 30 and an alternate sensitivity antenna 32. Sensitivity switch 28 can be used to regulate the sensitivity of RF receiver 26 by switching the connections between antenna 30 and alternate sensitivity antenna 32, where alternate sensitivity antenna 32 has a different sensitivity level from the sensitivity of antenna 30. RF receiver 26 is coupled to memory device 27, where memory device 27 is used for storing an audio file. When integrated circuit 25 receives a carrier signal from RF receiver 26 upon the detection of a call-back verification signal from a mobile telecommunications device by antenna 30 or alternate sensitivity antenna 32, integrated circuit 25 sends a signal to begin current flow from a control signal connection 34, through a control signal path 36 to a transistor amplifier 38. Current flow continues through transistor amplifier 38 on control signal path 36 to electronic switching relay circuit 16, switching relay switch 14 to its non-default position. Changing the switch position of relay switch 14 from default to non-default, interrupts audio path 12 from audio player device 10 and changes the connection to an audio file output line 40 leading from memory device 27 of integrated circuit 25. With relay switch 14 in its non-default position, an audio file stored in memory device 27 passes through audio file output line 40, through relay switch 14, and is routed to input connector 20 to be heard by audio output device 22. A deactivation switch 42 may be placed on control signal path 36, where in its opened position deactivation switch 42 would prevent the triggering of the electronic switching relay circuit 16 through control signal path 36, keeping relay switch 14 in its default position.

An automatic volume lowering control 44 may be coupled between manual volume control 18 and input connector 20 for allowing the adapter to lower the audio signal provided by audio player device 10 rather than completely shutting off the audio signal. Automatic volume lowering control 44 reduces the audio playback signal upon receiving a control signal through a secondary control signal path 46, the control signal initiated by RF receiver 26 when RF receiver 26 detects a call-back verification signal emitted from a cellular device.

Double Pole Double Throw (DPDT) switch 48 enables a series of switches to connect or disconnect two contacts within one line, while oppositely connecting or disconnecting two contacts within a second line. Thus, DPDT switch 48A is coupled to audio file output line 40 and DPDT switch 48B is coupled to a programmable memory output line 51. Programmable memory output line 51 connects a programmable memory device 52 containing erasable programmable memory to the non-default position of relay switch 14. Thus, when DPDT switch 48 is in its default state, DPDT switch 48A is closed and DPDT switch 48B is open, and in its non-default state DPDT switch 48B is closed and DPDT switch 48A is open. When DPDT switch 48 is in its default state, an audio file from memory device 27 is routed to electronic switching relay circuit 16 though audio file output line 40. When DPDT switch 48 is in the non-default position, a custom audio file provided by programmable memory device 52 is permitted to flow through the closed DPDT switch 48B. The audio file provided from memory device 27 is shut off from opened DPDT switch 48A, allowing custom audio files, or no audio files, to flow through relay switch 14 when relay switch 14 is activated by current provided by transistor amplifier 38 due to the reception of RF receiver 26.

Furthermore, in order to program programmable memory device 52 with a custom audio file, a programming DPDT switch 53 connects audio output line 17 to programmable memory device 52 through a data input line 55 when programming DPDT switch 53 is activated. Programming DPDT switch 53 causes signal path reversal, switching from audio output line 17, which has an output function, to data input line 55, which has an input function, allowing for customized programming of audio files into programmable memory device 52 by placing the unit into a “Sound-File” programming mode enabling a user to input any desired audio file to be used in place of the audio file provided on memory device 27. When programming DPDT switch 53 is not activated, audio output line 17 remains as the default with an output function.

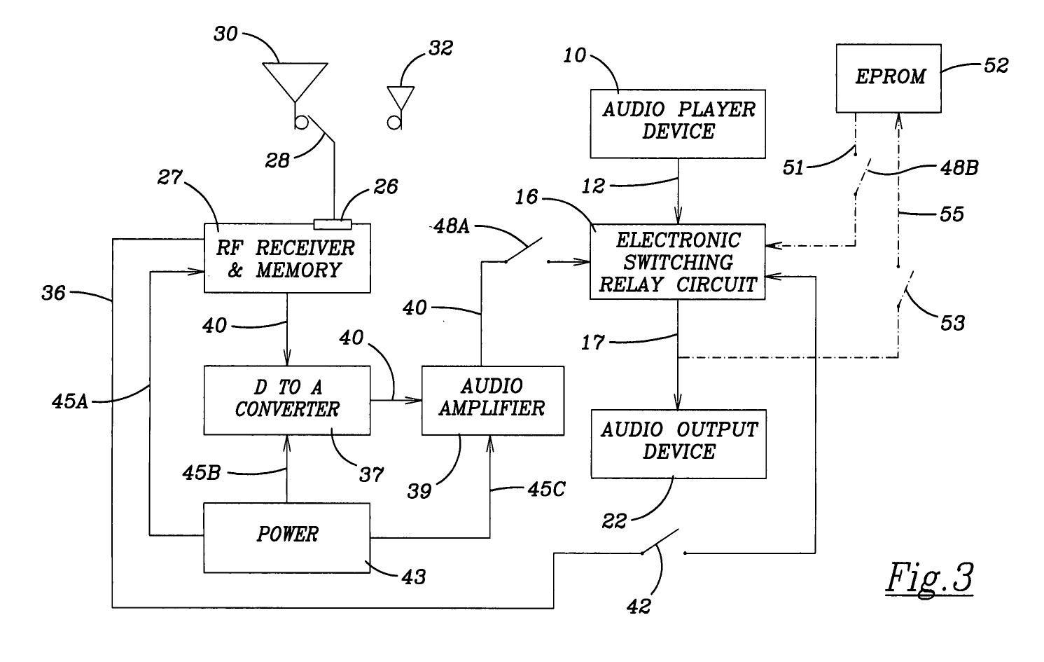

FIG. 3 shows the control and signal paths between and among the various electrical components in FIG. 2. An audio player device 10 is connected by an audio path 12 to an electronic switching relay circuit 16. An audio output line 17 connects an audio output device 22 to the opposite end of electronic switching relay circuit 16. In default position, electronic switching relay circuit 16 allows an audio signal to pass from audio player device 10 to audio output device 22. A RF receiver 26 is integrated with a memory device 27. RF receiver 26 is coupled with a sensitivity switch 28 to an antenna 30 and an alternate sensitivity antenna 32. RF receiver 26 is electrically coupled to electronic switching relay circuit 16 by a control signal path 36 intended to carry a control signal to activate electronic switching relay circuit 16. When the RF receiver 26 detects a call-back verification signal from a cellular phone through antenna 30 or alternate sensitivity antenna 32, RF receiver 26 initiates current to flow along a control signal path 36 to activate electronic switching relay circuit 16. Once activated, electronic switching relay circuit interrupts audio path 12 from audio output line 17 and remains in the activated position as long as the cellular device is in use and returns to the default position once the cellular phone ceases to transmit a carrier signal.

Memory device 27 is connected in series to a digital to analog converter 37 and an audio amplifier 39 by an audio file output line 40, where audio file output line 40 routes an audio file to the non-default position in electronic switching relay circuit 16. Switched to its non-default position, electronic switching relay circuit 16 routes an audio file provided through audio file output line 40 to audio output device 22 through audio output line 17.

A deactivation switch 42 placed on control signal path 36 may be used to prevent a control signal to be sent along control signal path 36 to trigger electronic switching relay circuit 16 when deactivation switch 42 is in its opened position. Deactivation switch 42 allows a user to switch off the phone alert function by cutting off any current flow intended to activate electronic switching relay circuit 16. Other areas are possible where deactivation switch 42 could be placed to disable the function as well, including coupling deactivation switch 42 between RF receiver 26 and sensitivity switch 28.

A power device 43 provides power to memory device 27, digital to analog converter 37, and audio amplifier 39 through power connections 45A, 45B, and 45C. A Double Pole Double Throw (DPDT) switch 48 enables a series of switches to connect or disconnect two contacts within one line; while oppositely connecting or disconnecting two contacts within a second line. Thus, DPDT switch 48A is coupled to audio file output line 40 and DPDT switch 48B is coupled to a programmable memory output line 51 as described above in connection with FIG. 2. Programmable memory output line 51 connects a programmable memory device 52 containing erasable programmable memory to the non-default position of electronic switching relay circuit 16. Thus, when DPDT switch 48 is in its default state, DPDT switch 48A is closed and DPDT switch 48B is open, and in its non-default state DPDT switch 48B is closed and DPDT switch 48A is open. When DPDT switch 48 is in its default state, an audio file from memory device 27 is routed to electronic switching relay circuit 16 though audio file output line 40. When DPDT switch 48 is in the non-default position, a custom audio file provided by programmable memory device 52 is permitted to flow through closed switch DPDT switch 48B. The audio file provided from memory device 27 is shut off from opened switch DPDT switch 48A, allowing custom audio files, or no audio files, to flow through electronic switching relay circuit 16 when electronic switching relay circuit 16 is activated by a control signal initiated by the reception of RF receiver 26.

Furthermore, in order to program programmable memory device 52 with a custom audio file, a programming DPDT switch 53 connects audio output line 17 to programmable memory device 52 through a data input line 55 when programming DPDT switch 53 is activated. Programming DPDT switch 53 causes signal path reversal, switching from audio output line 17, which has an output function, to data input line 55, which has an input function, allowing for customized programming of audio files into programmable memory device 52 by placing the unit into a “Sound-File” programming mode enabling a user to input any desired audio file to be used in place the audio file provided on memory device 27. When programming DPDT switch 53 is not activated, audio output line 17 remains as the default with an output function.

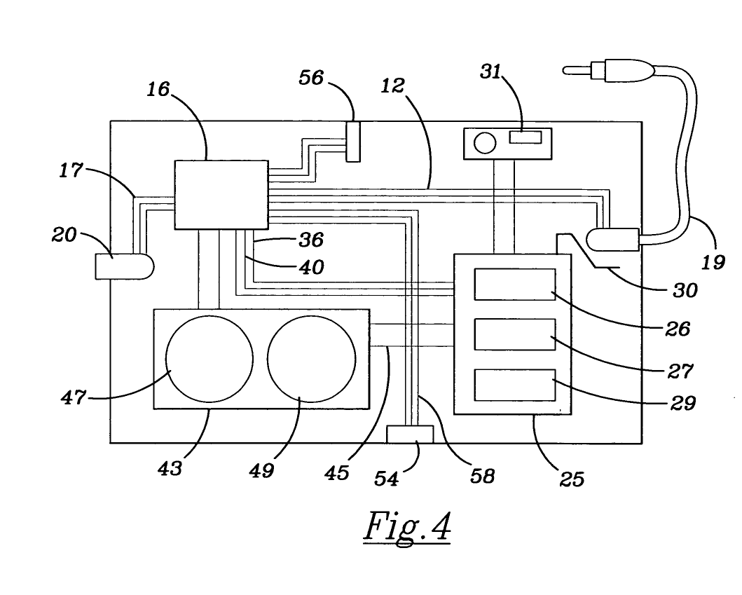

FIG. 4 shows one possible layout or configuration of the interconnection of components within the call alert adapter. An audio path 12 is coupled by an electronic switching relay circuit 16 to an audio output line 17. Audio path 12 connects electronic switching relay circuit 16 to an output connector 19. Output connector 19 being configured to be accepted by a female input jack of an audio player device. Audio output path 17 connects the opposite end of electronic switching relay circuit 16 to an input connector 20. Input connector 20 being configured to receive a male output jack from an audio output device. An integrated circuit 25 contains a RF receiver 26, a memory device 27, and a processor 29. An antenna 30 is coupled to RF receiver 26 for detecting a call-back verification signal sent from a cellular phone. When processor 29 detects an audio signal from the audio output device on audio output line 17, RF receiver 26 is switched on. A multi-position switch 31 may also be used to switch RF receiver 26 on or off.

RF receiver 26 upon receiving signal from a mobile phone on antenna 30 sends an internal signal to electronic switching relay circuit 16 through a control signal path 36. Electronic switching relay circuit 16 then interrupts the audio signal in audio path 12 and replaces it with an internal audio file sent from memory device 27 through an audio file output line 40. The audio file is then routed through electronic switching relay circuit 16 to the audio output line 17 which leads to the audio output device.

A power device 43 is connected to the components of integrated circuit 25 through a power connection 45. Power device 43 in this embodiment shows a first coin cell 47 and a second coin cell 49 for providing power, although other battery types may also suffice.

A mobile phone input jack 54 is mounted on the adaptor to accept a small cable, compatible with the audio output and input connectors from mobile phones, connecting a mobile phone to the adaptor. The small cable being the conduit to direct the audio from the adaptor to the mobile phone through a hard-wire path, allowing the user the convenience of hearing the incoming audio from the mobile phone while being able to speak into an add-on microphone connected to a microphone input jack 56 to facilitate a two way conversation without need of removing the headphones. The user when speaking into a small microphone attached by a cable into 56 microphone input jack feeds the audio signals produced by the user's voice through the adaptor back through the mobile phone audio input jack 54 into the mobile phone.

In addition, multi-position switch 31 can allow for the adaptor to switch into a secondary mode of activation useful in crowded conditions where other mobile phones may be in close proximity to the adaptor. The mobile phone upon receiving a call places an audio ring on a mobile phone input/output line 58 though a connection to the mobile phone provided by mobile phone input jack 54. Mobile phone input/output line 58 connects to processor 29. The audio ring is detected through processor 29, which in turn sends a signal to the electronic switching relay circuit 16, switching off the audio from the audio player device and re-routes audio path 12 to the mobile phone input/output 58 and microphone input 56. Multi-position switch 31 can also mute the microphone and headphones when a user wishes to cut off the audio input and output until the switch is moved back to its original position to allow the audio to pass through once again. This acts as a hold function commonly used on office phones. Multi-position switch 31 can also be used to activate the unit into a manual mode bypassing the auto-sound sensing mode of activation. Another purpose of multi-position switch 31 could be to allow for customized programming of sound files into the memory by placing the unit into a “Sound-File” programming mode enabling a user to input any desired audio file to be used in place of the internal ringing sound for alerting purposes through output connector 19.

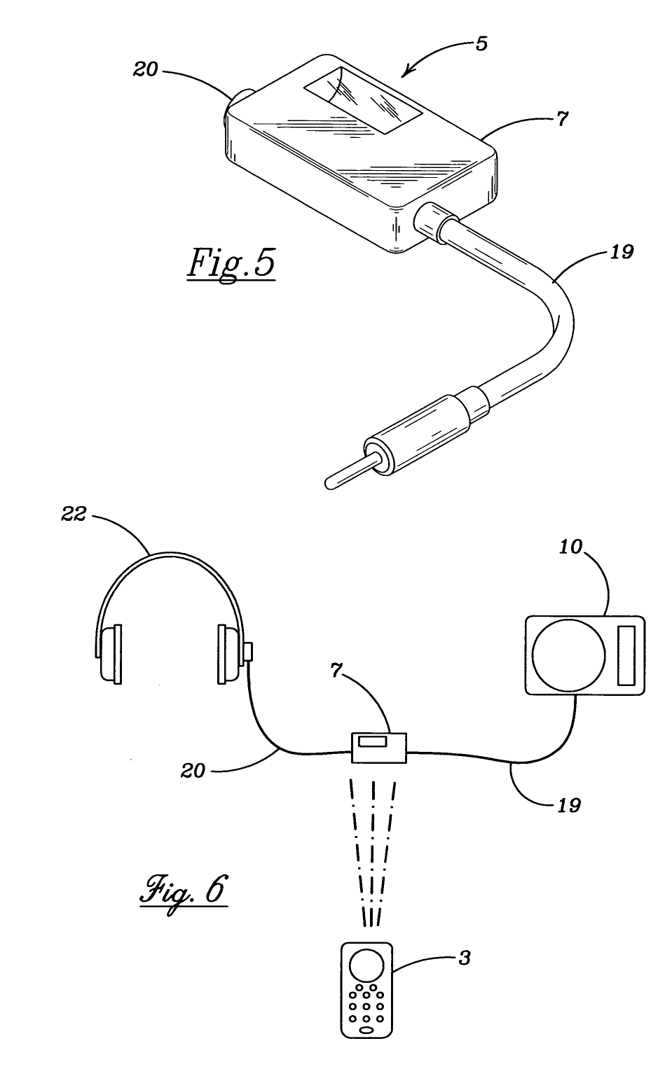

FIG. 5 shows one possible configuration of the present invention. An alert adapter 5 has a housing 7, an output connector 19, and an input connector 20. Housing 7 contains components associated with the present invention. Input connector 20 is coupled to components within housing 7. Output connector 19 is also coupled to components within housing 7. Output connector 19 is shown as being configured to be accepted by a female input jack of an audio player device, providing an audio path from an audio player device to alert adapter 5. Input connector 20 is shown as being configured to receive a male output jack from an audio output device, providing an audio output line from alert adapter 5 to an audio output device.

FIG. 6 shows one possible configuration of the present invention connected to an audio source, an audio output, and in proximity to a mobile phone. A mobile device 3 wirelessly communicates with components within housing 7 of the call alert adaptor. The components within housing 7 are also connected to an audio player device 10 through output connector 19 so that audio playback signals are applied to the call alert adapter. The components within housing 7 are also coupled to an input connector 20 so that the audio playback signals can be applied to an audio output device 22 such as a headset.

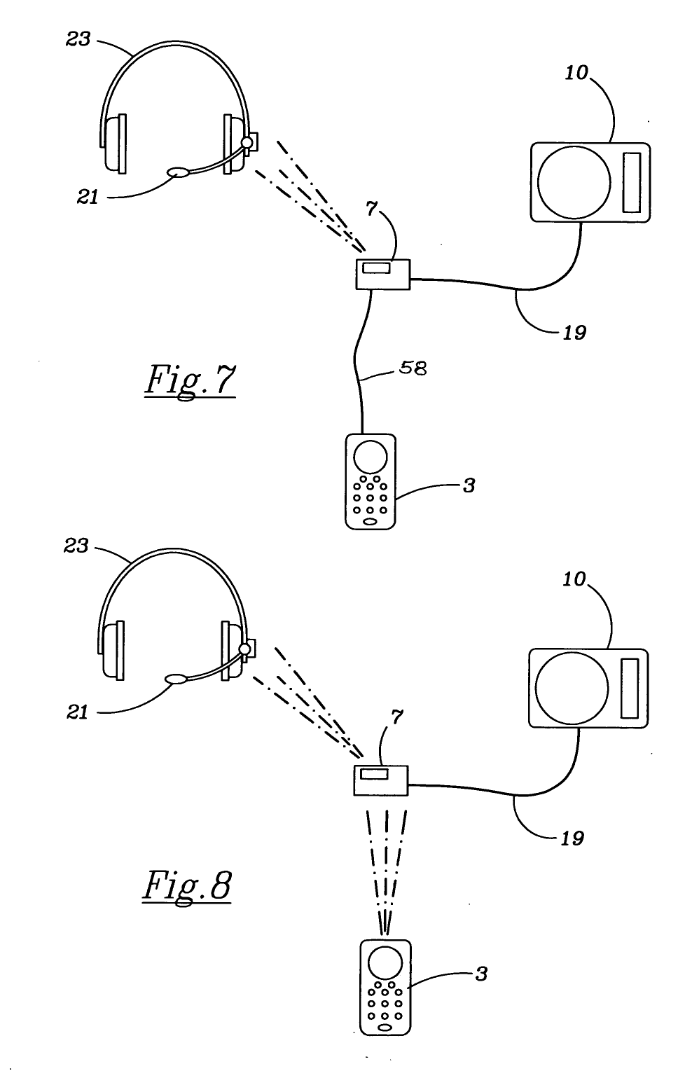

FIG. 7 shows a second possible configuration of the present invention connected to an audio source, an audio output, and in proximity to a mobile phone. A mobile device 3 communicates by wire with components within a housing 7 of a call alert adapter device. The components within housing 7 are connected to an audio player device 10 through an output connector 19 so that audio playback signals are applied to the call alert adapter. Mobile device 3 wirelessly communicates with a microphone 21 and a wireless audio output device 23 through components within housing 7 through a mobile phone input/output line 58 to permit two-way conversations when a call is received.

FIG. 8 shows a third possible configuration of the present invention connected to an audio source, an audio output, and in proximity to a mobile phone. A mobile device 3 communicates wirelessly with components within a housing 7 of a call alert adapter device. The components within housing 7 are connected to an audio player device 10 through an output connector 19 so that audio playback signals are applied to the call alert adapter. Mobile device 3 communicates with a wireless microphone 21 and a wireless audio output device 23 through the components within housing 7 by way of the wireless communications path between mobile device 3 and the call alert adapter device to permit two-way conversations when a call is received.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. An incoming call alert adapter comprising:
a. a primary audio path connecting an audio player device to a audio output device;
b. an electronic switching relay circuit electrically coupled to the primary audio path, where the primary audio path remains uninterrupted while the electronic switching relay circuit is in its default position, said the electronic switching relay circuit is configured to interrupt the audio signal of the audio player device upon receiving a control signal and to return to the default position when not receiving a control signal;
c. a control signal path for providing a means for detecting a control signal by the electronic switching relay circuit; and
d. an RF receiver, electrically coupled by the control signal path to the electronic switching relay circuit, configured to initiate and maintain a control signal sent along the control signal path to the electronic switching relay circuit upon detecting a call-back verification signal emitted from a mobile telecommunications device.

2. The incoming call alert adapter of claim 1, further comprising:
a. a memory device for storing an audio file;
b. an audio amplifier configured to receive an analog signal and to route the analog signal through the electronic switching relay circuit to the audio output device, wherein the electronic switching relay circuit provides an alternate audio path from the audio amplifier to the audio output device upon receiving a control signal; and
c. a digital to analog converter coupled between the memory device and the audio amplifier for converting a digital audio file into a call alert signal capable of being heard through an audio output device.

3. The incoming call alert adapter of claim 1, further comprising:
a. a programmable memory device; and
b. a means for accepting an audio file to be stored on the programmable memory device.

4. The incoming call alert adapter of claim 1, further comprising a deactivation switch for switching between on and off states of the alert function.

5. The incoming call alert adapter of claim 1, further comprising:
a. a plurality of reception antennas having at least two sensitivity levels of reception; and
b. a sensitivity switch electrically coupled between the plurality of reception antennas and the RF receiver, permitting the adjustment of the sensitivity of the RF receiver when detecting a call-back verification signal by switching between active antennas.

6. The incoming call alert adapter of claim 1, further comprising an automatic volume lowering control circuit electrically coupled to the RF receiver by means of a secondary control signal path, for reducing the audio signal provided from the audio player device upon receiving a control signal.

7. The incoming call alert adapter of claim 1, wherein the audio player device is selected from the group of devices having audio playback systems consisting of radio players, CD players, tape cassette players, DVD players, CVD players, and MPEG players.

8. The incoming call alert adapter of claim 1, wherein the audio output device is a headset.

9. The incoming call alert adapter of claim 8, further including a means for an external microphone to communicate with a mobile telecommunications device, the adapter configured to enable communication with the mobile telecommunications device through the microphone and headset, wherein the headset receives audio output from the mobile telecommunications device and the microphone transmits audio input to the mobile telecommunications device for enabling a two-way conversation to be carried on through means of the mobile telecommunications device when the primary audio path is interrupted.

10. The incoming call alert adapter of claim 9, further including a mute switch, having on and off states, communicating with the audio path of the headset and the external microphone, for cutting off the audio input and output of the mobile telecommunications device when the mute switch is in its on state.

11. The incoming call alert adapter of claim 1, further comprising:
a. an input line electrically coupling the electronic switching relay circuit to the mobile telecommunications device;
b. a means for detecting an audio ring of a mobile telecommunications device and initiating a control signal upon the detection of the audio ring to be sent to the electronic switching relay circuit, interrupting the primary audio path; and
c. a multi-position switch, having:
i. a primary mode, where the RF receiver detects a call-back verification signal, initiating the interruption sequence of the primary audio path; and
ii. a secondary mode, where the audio ring is detected by the means for detecting an audio ring, initiating the interruption sequence of the primary audio path.

12. A method for alerting users of audio output devices to incoming calls from nearby mobile telecommunications devices comprising the steps of:
a. detecting a call-back verification signal emitted from a mobile communications device by a RF receiver;
b. generating a control signal after the RF receiver detects a call-back verification signal, the control signal to be sent along a primary control signal path to a electronic switching relay circuit configured to interrupt the audio output of the audio player device upon receiving a control signal;
c. maintaining a control signal while the RF receiver detects a call-back verification signal; and
d. interrupting a primary audio path connecting and audio player device to an audio output device upon the electronic switching relay circuit receiving a control signal.

13. The method for alerting users of audio output devices to incoming calls from nearby mobile telecommunications devices in claim 12, further comprising the steps of:
a. storing an audio file on a memory device;
b. converting a digital audio file into a call alert signal through a digital to analog converter coupled to the memory device;
c. amplifying the call alert signal outputted from the digital to analog converter through an audio amplifier, for enabling the call alert signal to be heard through an audio output device; and
d. routing the call alert signal through a secondary audio path to the electronic switching relay circuit, where the electronic switching relay circuit connects the alternate audio path to the audio output device upon the detection of a control signal.

14. The method for alerting users of audio output devices to incoming calls from nearby mobile telecommunications devices in claim 12, further including the step of switching between on and off states of the call alert function through a deactivation switch.

15. The method for alerting users of audio output devices to incoming calls from nearby mobile telecommunications devices in claim 12, further including the step of:
a. regulating the sensitivity level of reception of the RF receiver when detecting a call-back verification signal by switching between a plurality of reception antennas coupled to a sensitivity switch, the plurality of reception antennas having at least two sensitivity levels of reception for permitting the adjustment of the sensitivity of the RF receiver.

16. The method for alerting users of audio output devices to incoming calls from nearby mobile telecommunications devices in claim 12, further including the step of:
a. reducing the audio signal provided from the audio player device by regulating the primary audio path through an automatic volume lowering control circuit electrically coupled to the RF receiver by means of a secondary control signal path, where the audio signal is reduced upon the automatic volume lowering control circuit receiving a control signal.

17. The method for alerting users of audio output devices to incoming calls from nearby mobile telecommunications devices in claim 12, wherein the audio player device is selected from the group of devices having audio playback systems consisting of radio players, CD players, tape cassette players, DVD players, CVD players, and MPEG players.

18. The method for alerting users of audio output devices to incoming calls from nearby mobile telecommunications devices in claim 12, wherein the audio output device is a headset.

19. The method for alerting users of audio output devices to incoming calls from nearby mobile telecommunications devices in claim 12, further including the step of:
a. providing a means for communicating with a mobile telecommunications device through a headset and an external microphone, wherein the adapter is configured to communicate with the headset and the external microphone, the headset receiving audio output from the mobile telecommunications device and the external microphone transmits audio input to the mobile telecommunications device for enabling a two-way conversation to be carried on through means of the mobile telecommunications device when the primary audio path is interrupted.

20. The method for alerting users of audio output devices to incoming calls from nearby mobile telecommunications devices in claim 12, further including the steps of:
a. detecting an audio ring of a mobile telecommunications device through an input line electrically coupling the electronic switching relay circuit to the mobile telecommunications device; and
b. initiating a control signal upon the detection of the audio ring to be sent to the electronic switching relay circuit through a control signal path, interrupting the primary audio path.
